(19) United States
(12) Patent Application Publication
(10) Pub. No.: US 2024/0056418 A1
(43) Pub. Date: Feb. 15, 2024

(54) METHOD FOR ADDRESS CONFIGURATION FOR A MASTER-SLAVE SYSTEM

(71) Applicant: BEKO TECHNOLOGIES GMBH, Neuss (DE)

(72) Inventors: Norbert STRACK, Kempen (DE); Jürgen EGGELING, Mülheim an der Ruhr (DE); Reiner WITTENHORST, Wuppertal (DE)

(21) Appl. No.: 18/258,005

(22) PCT Filed: Dec. 7, 2021
(86) PCT No.: PCT/EP2021/084565

§ 371 Date: Jun. 16, 2023

(30) Foreign Application Priority Data
Dec. 18, 2020 (DE) 10 2020 134 167.9

(51) Int. Cl. H04L 61/5038; H04L 61/5046; H04L 12/40; H04L 12/403

(52) U.S. Cl. CPC H04L 61/5038; H04L 61/5046; H04L 12/40169; H04L 12/40032; H04L 12/403; H04L 2012/40228; H04L 2101/695

(57) ABSTRACT

A method for address configuration for a master/slave system via a field bus for serial data transmission, wherein a master unit is connected to the field bus, is characterized in that a number range for addresses of slave units on the field bus is divided into a static range and a dynamic range, that at least one new slave unit is connected to the field bus, that a respective initial field bus address from the dynamic range is programmed into the at least one new slave unit, via which initial field bus address the at least one new slave unit can respectively be addressed. The master unit queries the dynamic range of the addresses of slave units, the master unit receives a respective response message from the at least one new slave unit to the query, and the master unit transmits a target field bus address.

### CROSS-REFERENCE TO RELATED APPLICATIONS

This application is a 35 U.S.C. § 371 National Stage patent application of PCT/EP2021/084565 filed 7 Dec. 2021, which claims the benefit of German patent application 10 2020 134 167.9 filed 18 Dec. 2020, the disclosures of which are incorporated herein by reference in their entirety.

### TECHNICAL FIELD

The disclosure relates to a method for address configuration for a master/slave system via a field bus with the features of the generic term of claim 1, a method for address configuration for a master/slave system via a field bus with the features of the generic term of claim 14, a master unit for a master/slave system with the features of the generic term of claim 15, and a master/slave system having a field bus for serial data transmission with the features of the generic term of claim 16.

### BACKGROUND

Various field bus systems are known from prior art, with which different sensors or actuators can also be connected to control or data logger units. Such field bus systems usually have a comparatively low bandwidth and a comparatively simple data transmission protocol. This makes it possible to use less complex electronic devices for communication on the field bus, which, in turn, makes it possible to provide such devices at a low cost. In this way, a plurality of simple and therefore, also cost-effective sensors or actuators can be connected to the field bus in a cost-effective way. Furthermore, field bus systems are often characterized by particular robustness and reliability in data transmission.

A field bus system known from the state of the art is the MODBUS, which is defined in different variants both at the physical level as well as at higher levels. Information on MODBUS from the state of the art can be found, in particular, in the document “MODBUS over Serial Line Specification and Implementation Guide V1.02”, which can be accessed from the modbus.org website. The disclosure is based on this document, being the closest to it.

In the case of a field bus in accordance with MODBUS, a master unit with a plurality of slave units is provided. Within the prescribed address space, which can be represented by 1 byte and thus a total of 8 bits, each slave unit should be assigned a unique number and thus an address, via which address the slave unit can then be addressed by the master unit for data transmission.

The problem with such field buses based on the master/slave principle, however, is that the operator of the respective field bus must ensure that these unique addresses of the slave units are managed himself/herself. He/she must therefore not only assign and manage the corresponding addresses on an organizational level, but also ensure that each slave unit has programmed its correct address. The process of programming the address is not only often different for each slave unit but may also be time-consuming.

U.S. Pat. No. 8,190,697 B2 from the prior art describes a method for dynamic address assignment for a field bus according to the master/slave approach in accordance with MODBUS. The method specifically provides that slave units can be put into a pseudo-master mode, in which they can send a message to the master independently and thus without being asked to do so by the master. In this way, slave units can dynamically “report” to the master via the field bus, which can thus be informed about new slave units on the field bus.

The disadvantage of the approach in prior art is that it drastically interferes with the paradigm of the master/slave system. Slaves must therefore be given the opportunity to send a message via intrinsic initiative. Likewise, the master must be able to receive and also process a message sent in this way. The devices on the field bus must therefore function in a way that contradicts the actual principle of the field bus. This can be a problem, particularly for existing devices that have not been programmed or reprogrammed specifically for this deviating approach.

### SUMMARY

Based on this prior art, the disclosure therefore enables the process of dynamically assigning addresses to slave units in a manner that is more closely orientated on the existing field bus protocol.

With reference to the method of address configuration for a master/slave system via a field bus with the features of the generic term of claim 1, the task is solved by the features of the characterizing part of claim 1. With respect to the method of address configuration for a master/slave system via a field bus with the features of the generic term of claim 14, the task is solved by means of the features of the characterizing part of claim 14. With respect to the master unit for a master/slave system with the features of the generic term of claim 15, the task is solved by means of the features of the characterizing part of claim 15. With reference to a master/slave system with a field bus for serial data transmission with the features of the generic term of claim 16, the task is solved by means the features of the characterizing part of claim 16.

Knowledge deemed essential the disclosure entails that, by dividing the address range for the slave units into at least two ranges, dynamic address assignment can be implemented. Namely, newly connected slave units are initially either assigned a random or pseudo-random address in the first range or programmed into them in some other way, which first range can be called dynamic range. This dynamic range is examined by the master unit in sequence by queries. If exactly one slave unit is found at an address in the dynamic range, it is assigned a new address in the second range, and this is recorded. Since, after an assignment of an address from this range, this address is deemed valid until further notice, this range can also be referred to as a static range. In this way, it becomes possible to connect slave units to a field bus during its operation and to configure them.

The proposed method of a first aspect of the disclosure is used to configure the address for a master/slave system via a field bus for serial data transmission, wherein a master unit is connected to the field bus. In addition to the data line, the field bus can also comprise other lines, such as a line for a supply voltage and a ground line. It is preferable that the field bus provides serial data transmission via a two-pole data line. Preferably, the line provides a voltage of at least 20 volts for the supply voltage, in particular, essentially 24 volts. However, the data transmission as such preferably takes place via exactly two poles or leads. The master unit can be a basically arbitrary device that at least temporarily takes over the role of the master in communication via the field bus.

It is preferable that the field bus has a physical interface in accordance with EIA-485. EIA-485 is also known as RS-485. It is preferable that the field bus has a power line to provide a supply voltage, which supply voltage is preferably essentially 24 V. It is also preferred that the field bus has a ground line and/or shielding.

The proposed method of the first aspect of the disclosure is characterized in that a number range for addresses of slave units on the field bus is divided into a static range and a dynamic range. Here it is preferred that the number range for addresses can be encoded by 8 bits. This means that the number range can consist of up to 256 addresses. The dynamic range and the static range are disjoint to one another. This means that each address can only belong to either the dynamic range or the static range. There may be addresses that do not belong to either the dynamic range or the static range, for which an example is described below. There cannot be addresses that belong to both. In principle, the static range and the dynamic range do not have to be closed ranges. For example, it could be that the dynamic range consists of even addresses and the static range consists of odd addresses. However, it is preferable that the static range and the dynamic range form a closed address range. In other words, there is no address in the dynamic range between two addresses in the static range and vice versa.

In principle, the static range and the dynamic range can be of any size. However, it is preferable that the static range is larger than the dynamic range and in particular that the static range is at least three times as large as the dynamic range. In other words, the static range has at least three times as many addresses as the dynamic range. A preferred variant is that the dynamic range consists of exactly one address. This address can then be referred to as the fixed initial address. It may be that both the static range as well as the dynamic range are respectively fixed. However, it may also be that both the static range as well as the dynamic range are fundamentally variable.

The proposed method of the first aspect of the disclosure is furthermore characterized in that at least one new slave unit is connected to the field bus, that a respective initial field bus address from the dynamic range is programmed into the at least one new slave unit, via which initial field bus address the at least one new slave unit can be respectively addressed, and that the master unit queries the dynamic range of the addresses of slave units. Here, the at least one new slave unit and those in the following refer to slave units for which an address configuration takes place as described.

The fact that a respective initial field bus address from the dynamic range is programmed into the at least one new slave unit can basically be accomplished in any way. This state can therefore be accomplished both by programming from the outside—i.e., from outside the new slave unit—as well as via a process that takes place purely within the new slave unit. Such programming may also have already taken place during the production of the new slave unit.

In addition to at least one new slave unit, other slave units may be connected to the field bus for which the address configuration described here is not carried out. These other slave units can then simply keep the address that is assigned to them. It can be that the other slave units that are connected to the field bus and for which the address configuration described here is not carried out are assigned an address that is located in a predefined legacy-system range of addresses. This legacy range of addresses is disjoint to the static range and to the dynamic range. In other words, each address can belong to a maximum of one range from the group of a static range, a dynamic range, and a legacy-system range. Preferably, the legacy-system range of the master unit is known. Likewise, the addresses of the other slave units for which the address configuration described here is carried out and which are located in the legacy-system range can be known to the master unit. In particular, these addresses can be programmed manually into the master unit. However, these addresses can also be communicated to the master unit by other means.

In principle, the dynamic range can be queried by the master unit as often as desired. It is not necessary for the dynamic range to be fully queried. In this respect, it may be that the dynamic range is queried once. It may also be that the dynamic range is queried at irregular intervals or in response to an external event. It is preferable that the dynamic range is queried cyclically or periodically. In particular, the dynamic range may be queried with an interval or period which is between 1 second and 5 minutes, preferably between 10 seconds and 3 minutes, and, in particular, between 30 seconds and 2 minutes.

The proposed method of the first aspect of the disclosure is furthermore characterized in that the master unit receives a respective response message from the at least one new slave unit to the query, that the master unit transmits a target field bus address from the static range to at least one new slave unit so that the target field bus address is programmed into the at least one new slave unit instead of the initial field bus address and so that the at least one new slave unit can be addressed via the target field bus address. The response message is received in response to the aforementioned queries. Querying the dynamic range may also include a readout of at least one new slave unit at the addresses of the dynamic range.

A preferred embodiment of the proposed method of the first aspect of the disclosure is characterized in that querying the dynamic range involves sending a respective query message per address in the dynamic range, wherein the respective query message is addressed to a single address in the dynamic range. The query message can also be a readout message or a readout command.

In principle, the target field bus address from the static range can be of any origin. It is preferable that the master unit determines the target field bus address. In particular, this determination can be done based on the response message.

Another preferred embodiment of the proposed method of the first aspect of the disclosure is characterized in that the response message includes device identification data. In particular, the device identification data may include device type information to specify a device type of the respective new slave unit. The advantage of querying the device identification data is that the length of the device identification data increases the probability of a collision in the event that more than one new slave unit is assigned the same address in the dynamic range. It is preferred that the query message be the “Read Device Identification” message, preferably in accordance with the MODBUS protocol.

In particular, the master unit sends a message to the respective new slave unit to read out the device identification data, wherein this message in particular can be understood as a query message or as a readout command, whereupon this new slave unit sends a message with the desired device identification data to the master unit, which in turn receives this message. In the context of MODBUS, for example, it is a “request” and an associated “reply”.

The target field bus address can be basically any address from the static range. The above determination of the target field bus address can also be carried out basically arbitrarily on the basis of the device identification data. On the one hand, it is conceivable that the target field bus address is determined on the basis of a table from the response message or the device identification data, i.e., that a target field bus address is assigned to a part or even all possible device identification data. On the other hand, it can also be that, in addition to the device identification data, other data, which can also be determined randomly or pseudo-randomly, are also included in the determination of the target field bus address. Programming the target field bus address means nothing other than that the new slave unit then uses this target field bus address as the new address for addressing via the field bus.

In principle, the dynamic range can be queried by the master unit in any and, in particular, also in random or pseudo-random order. A preferred embodiment of the proposed method of the first aspect of the disclosure is characterized in that the master unit queries the dynamic range of the addresses of slave units by successively querying a series of preferably descending or ascending addresses. In other words, the address queried is either always higher or always lower than the previously queried address, wherein, of course, there is a jump forward or backward again from a certain address. In particular, it may be a continuous series of addresses. This means that the series of queried addresses is complete.

In principle, in addition to querying the device identification data in particular, any further communication can take place between the master unit and the at least one new slave unit. Another preferred embodiment of the proposed method of the first aspect of the disclosure is characterized in that, prior to querying the dynamic range, the master unit sends out a configuration command in the broadcast via which the at least one new slave unit is put into a configuration mode. Preferably, a random address from the dynamic range is programmed into the new slave units in configuration mode as an initial field bus address. In particular, this random address can be an address that has been determined pseudo-randomly. In particular, it may be that the random address is generated by the new slave unit itself.

For programming the random address, the same applies mutatis mutandis as was already stated above for programming the initial field bus address. In particular, the programming of the random address can be a process that takes place purely within the new slave unit.

The configuration command therefore preferably has the consequence that the at least one new slave unit is put into configuration mode and thus into a state in which the target field bus address can be programmed. In this context, on the one hand, the configuration command itself can have the consequence that the initial field bus address is determined or programmed as the address of the new slave unit. However, it is also possible that the programming or determination of the respective initial field bus address as an address is carried out on another command in addition to the configuration command, which further command is sent out after the configuration command. Sending the configuration command in the broadcast means that not exactly one new slave unit is addressed by the configuration command, but rather a plurality of new slave units or even all new slave units are addressed equally. The initial field bus address can be determined both randomly as well as pseudo-randomly and is a random address in both cases.

In accordance with a preferred embodiment of the proposed method of the first aspect of the disclosure, it is envisaged that before the configuration command is sent out, the master unit sends out an unlocking command in the broadcast via which at least one new slave unit is programmed to be put into configuration mode upon receipt of the configuration command. Sending out the unlocking command in the broadcast means that not exactly one new slave unit is addressed by the unlocking command, but that a plurality of new slave units or even all new slave units are addressed by the unlocking command. The unlocking command and, if applicable, the configuration command are therefore preparatory measures before querying the dynamic range.

It is not necessary for all slave units to be put into configuration mode by the configuration command in the broadcast or to react to the unlocking command. In particular, it may be that the other slave units in the legacy-system range react differently or not at all to the configuration command and/or to the unlocking command.

In accordance with a further preferred embodiment of the proposed method of the first aspect of the disclosure, it is envisaged that the master unit, after transmitting the target field bus address, transmits a locking command to the at least one new slave unit, via which at least one new slave unit is programmed to ignore the configuration command. In this way, at least one new slave unit, which was previously unlocked, and which received and accepted the target field bus address from the static range, is locked again. This makes it possible to send the configuration command back in the broadcast without assigning an address in the dynamic range to those new slave units that have already been assigned an address in the static range. This also makes it possible to send out the configuration command again in the broadcast in the event of collisions and to leave the already configured new slave units configured.

In principle, the response message and the device identification data can include any other information. A preferred embodiment of the proposed method of the first aspect of the disclosure is characterized in that the response message or device identification data includes a manufacturer's information to specify a manufacturer of the respective new slave unit, a serial number of the respective new slave unit, a software version number to indicate a version of a software on the respective new slave device, production data to indicate information about the production of the respective new slave unit and/or specification data for the specification of the respective new slave unit.

In principle, only one new slave unit may be connected to the field bus. A further preferred embodiment of the proposed method of the first aspect of the disclosure is characterized in that a plurality of new slave units is connected to the field bus, that a respective initial field bus address is programmed into each new slave unit of the plurality of new slave units, via which respective initial field bus address the respective new slave unit can be addressed, and that the master unit receives the respective response message from receives at least one new slave unit of the plurality of new slave units. In this way, the address configuration can be made for a plurality of newly connected new slave units simultaneously.

In accordance with a preferred embodiment of the proposed method of the first aspect of the disclosure, it is envisaged that if the master unit receives the respective response message from exactly one new slave unit of the plurality of new slave units, the master unit transmits to exactly one new slave unit the target field bus address, wherein the target field bus address is programmed into the exactly one new slave unit instead of the initial field bus address so that the new slave unit can be addressed via the target field bus address. In such a case, the queried initial field bus address is programmed into only one new slave unit so that only one new slave unit also responds to the query. It is also preferable that after the transfer of the target field bus address to exactly one new slave unit, the master unit queries a next address in the dynamic range.

Basically, in the case in which the query of an address in the dynamic range is not responded to by a new slave unit but by a plurality of new slave units, it is possible to react in different ways. In accordance with a further preferred embodiment of the proposed method of the first aspect of the disclosure, it is envisaged that if the master unit receives the respective response message from more than one new slave unit of the plurality of new slave units in response to a query of an address from the dynamic range, the master unit will query a next address from the dynamic range. The first step is to search for an address in the dynamic range where only one new slave unit responds to the query so that it can be provided with an address in the static range.

A preferred embodiment of the proposed method of the first aspect of the disclosure is characterized in that when the master unit, in response to a query of an address from the dynamic range, receives the respective response message from more than one new slave unit of the plurality of new slave units, the master unit puts more than one new slave unit into a configuration mode so that a respective random address from the dynamic range is classified as an initial field bus address is programmed into the respective more than one new slave unit. Preferably, the more than one new slave unit is put into configuration mode by sending out the configuration command in the broadcast by the master unit. The aim here is therefore that through the new assignment of random addresses—which can also be pseudo-random—those new slave units that previously had a common initial field bus address now have different initial field bus addresses so that no collision occurs anymore. This approach can be repeated until all slave units with an address in the dynamic range have been assigned a unique address in the static range.

The fact that the master unit receives the respective response message from more than one new slave unit to the query, i.e., that there is a collision with the queried address from the dynamic range, can in principle be determined in any way. A further preferred embodiment of the proposed method of the first aspect of the disclosure is characterized in that the reception of the respective response message from more than one new slave unit of the plurality of new slave units by the master unit is determined on the basis of a respective check value of the respective response message. In other words, there are errors in the check value of the response messages, from which the collision can be concluded. It is preferable that the respective test value was generated by a cyclic redundancy check.

Together with the determination of the target field bus address, further information—again deterministic, random or pseudo-random—can also be determined and then used to configure the respective new slave unit. A preferred embodiment of the proposed method of the first aspect of the disclosure is characterized in that, based on the response message, preferably based on the device identification data, an additional information set is obtained from a device database and the new slave unit is programmed based on the additional information set. This additional information set can basically serve any purpose. It is preferable that a measurement range and/or measurement units and/or a measurement resolution and/or a calibration cycle of the new slave unit be programmed based on the additional information set. In this way, it can be ensured that values measured by the new slave unit are not called into question by faulty measurement ranges or by a calibration cycle that deviates from the specifications.

Similarly, user data may be entered by a user and the re-slave unit may be programmed based on the user data. In this case, it may be that at least part of the response message, preferably the device identification data, was presented to the user before the user data was entered. In this way, the data from the new slave unit can be reacted to by the user's input, i.e., by providing the user data that is appropriate from the user's point of view for this particular new slave unit.

A preferred embodiment of the proposed method of the first aspect of the disclosure is characterized in that at least a subset of at least one new slave unit is electrically supplied for operation via the power line of the field bus. In this way, there is no need for a cable separate from the field bus for the electrical supply for at least one new slave unit.

The proposed method of a second aspect of the disclosure is used to configure the address for a master/slave via a field bus for serial data transmission, wherein a master unit is connected to the field bus.

The proposed method of the second aspect of the disclosure is characterized in that a number range for addresses of slave units on the field bus is divided into a static range and a dynamic range, that a new slave unit is connected to the field bus, that a respective initial field bus address from the dynamic range is programmed into the new slave unit, via which initial field bus address the new slave unit can be respectively addressed, that the new slave unit transmits a response message to the master unit in response to a query from the master unit, that the new slave unit receives a target field bus address from the static range from the master unit, and that the target field bus address is programmed into the new slave unit instead of the initial field bus address so that the new slave unit can be addressed via the target field bus address.

The proposed master unit is for a master/slave system, which master/slave system uses a field bus for serial data transmission, wherein the master unit can be connected to the field bus.

The proposed master unit is characterized in that a number range for addresses of slave units on the field bus is divided into a static range and a dynamic range, that the master unit is set up to query the dynamic range of the addresses of slave units, that the master unit is set up to receive a response message to the query from the at least one new slave unit, that the master unit is set up to transmit a target field bus address from the static range to at least one new slave unit so that the target field bus address is programmed into the at least one new slave unit instead of the initial field bus address and so that at least one new slave unit can be addressed via the target field bus address.

The proposed master/slave system has a field bus for serial data transmission.

The proposed master/slave system is characterized in that the master/slave system has a master unit according to the proposal, which is connected to the field bus.

The proposed master/slave system is furthermore characterized in that the master/slave system has a new slave unit connected to the field bus, that a respective initial field bus address from the dynamic range is programmed into the new slave unit, via which initial field bus address the new slave unit can be addressed, that the new slave unit is set up to send a response message to the master unit in response to a query from the master unit, that the new slave unit is set up to receive a target field bus address from the static range from the master unit, and that the new slave unit is set up to program the target field bus address instead of the initial field bus address so such a way that the new slave unit can be addressed via the target field bus address.

Preferred embodiments, features and properties of the proposed method of the first aspect of the disclosure correspond to those of the proposed method of the second aspect of the disclosure, the proposed master unit and/or the proposed master/slave system. This also applies mutatis mutandis in reverse.

### BRIEF DESCRIPTION OF THE DRAWINGS

Further favourable and preferred embodiments result from the following description with reference to the figures. In the drawing, which only renders an exemplary embodiment, the figures show:

FIG. 1 a schematic view of an exemplary embodiment of a proposed master/slave system with a proposed master unit for executing the proposed methods in a first state,

FIG. 2 the exemplary embodiment of FIG. 1 in a second state after the first state,

FIG. 3 the exemplary embodiment of FIG. 1 in a third state after the second state,

FIG. 4 the exemplary embodiment of FIG. 1 in a fourth state after the third state,

FIG. 5 the exemplary embodiment of FIG. 1 in a fifth state after the fourth state, and

FIG. 6 the exemplary embodiment of FIG. 1 in a sixth state after the fifth state.

### DETAILED DESCRIPTION OF THE DRAWINGS

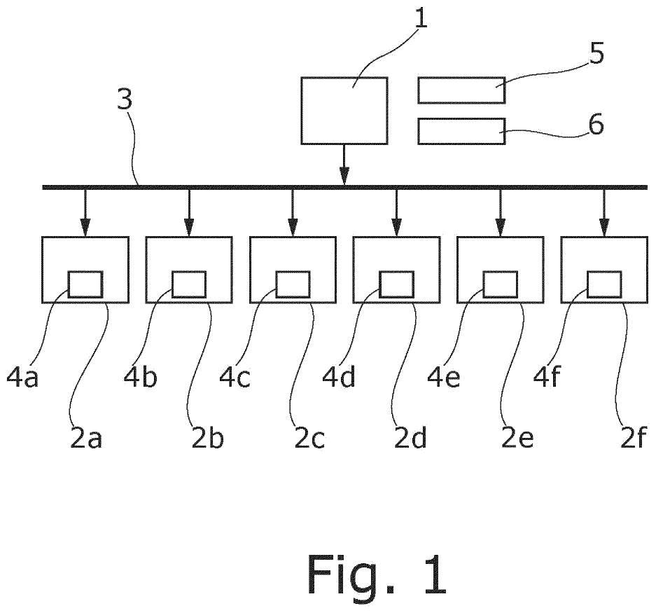

In the case of the one shown in FIG. 1, a master unit 1 and a total of six new slave units 2a-f are connected to a field bus 3, which complies with the MODBUS standard. The physical interface of the field bus corresponds to EIA-485, which is also referred to as RS-485. The new slave units 2a-f are different types of industrial sensors.

In the case shown in FIG. 1, the master unit 1 first sent out an unlocking command 5 and then a configuration command 6 in the broadcast so that all new slave units 2a-f received both commands. The purpose of the unlocking command 5 is to “unlock” the receiving new slave units 2a-f in the sense that they react to the configuration command 6 at all, namely by putting them into a configuration mode in response to the configuration command 6. Without a previously received unlocking command 5, the new slave units 2a-f ignore the configuration command 6. However, since all new slave units 2a-f have received unlocking command 5, all new slave units 2a-f are also set to configuration mode by configuration command 6. In the present case, via the configuration command 6, a pseudo-randomly generated initial field bus address 4a-f from the dynamic range, which corresponds to the slave address for communication via field bus 3, is programmed into the previously unlocked new slave units 2a-f—in this case, all new slave units 2a-f.

The dynamic range includes the values from 201 to 246 and the static range the values 31 to 200. The addresses of both the dynamic range as well as the static range can be recognized, thereby being capable of being encoded via one byte—i.e., 8 bits. The first initial field bus address 4a of the first new slave unit 2a has the value 246, the second initial field bus address 4a of the second new slave unit 2b has the value 224, the third initial field bus address 4c of the third new slave unit 2c has the value 238, the fourth initial field bus address 4d of the fourth new slave unit 2d has the value 231, the fifth initial field bus address 4e of the fifth new slave unit 2e has the value 214 and the sixth initial field bus address 4f of the sixth new slave unit 2f also has the value 231. Thus, the fourth new slave unit 2d and the sixth new slave unit 2f each have an identical initial field bus address 4d, f.

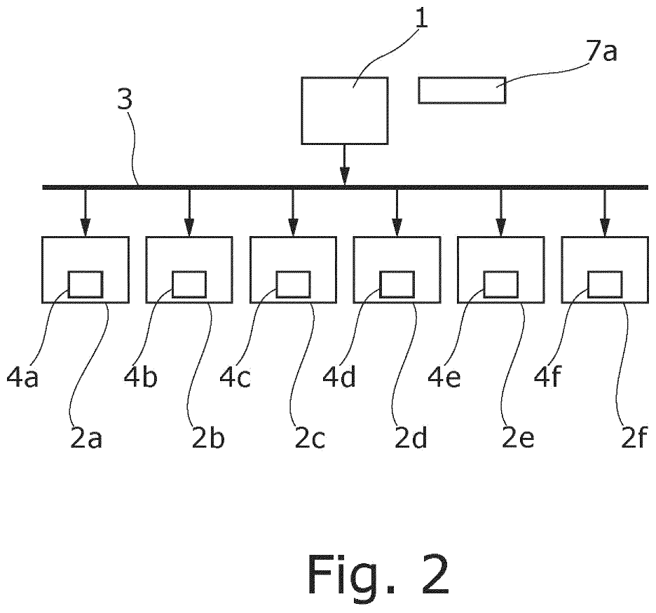

In the state of FIG. 2, a query of the dynamic range up to the address 213 takes place. For this query, the master unit 1 sends a readout command to read out the device identification data, for which a first readout command 7a is shown here as an example, to the corresponding address, i.e., one readout command 7 to the addresses 201 to 213 successively. Since none of the new slave units 2a-f connected to field bus 3 has an initial field bus address 4a-f in this range, there is also no reaction in the form of a response from one of the new slave units 2a-f.

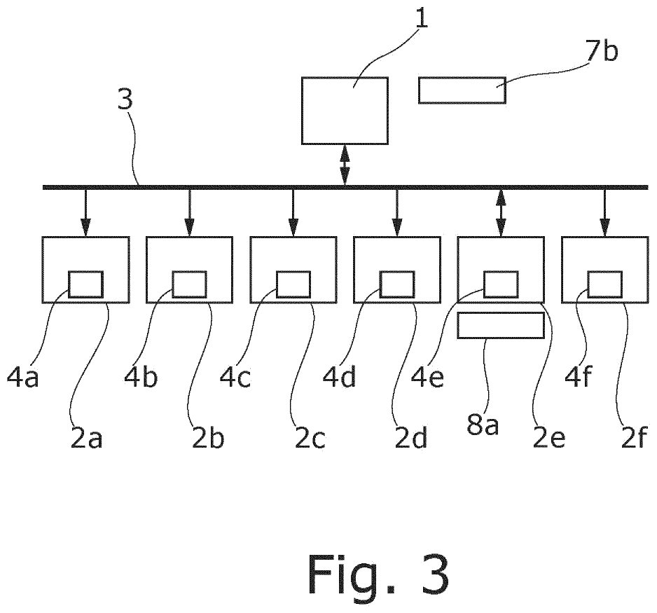

In the state of FIG. 3, the master unit 1 queries the address 214 in the dynamic range by sending a second readout command 7b to exactly this address. The fifth new slave unit 2e responds to this by transmitting the first device identification data 8a in a response message to the master unit 1, which consequently receives it. In addition to the device type information, which describes the type of industrial sensor that forms the new slave unit 2e, this first device identification data 8a includes an indication of the manufacturer of the new slave unit 2e, a serial number of the new slave unit 2e and a software version number of the software running on the new slave unit 2e.

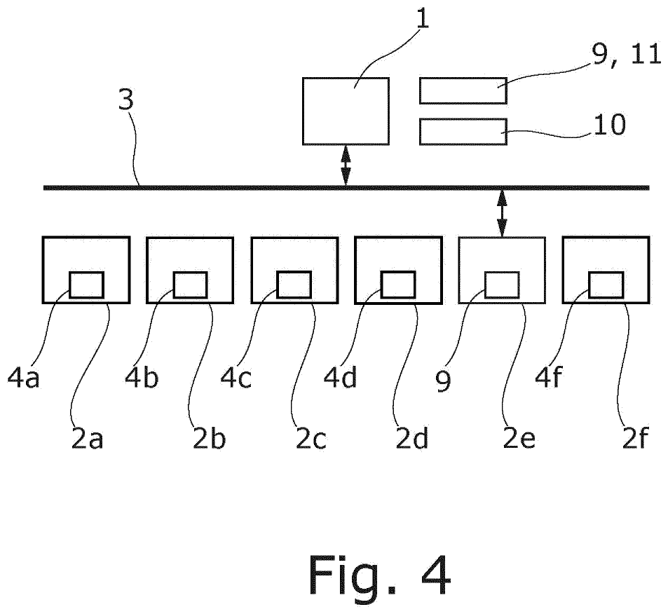

In the state of FIG. 4, the master unit 1 determines a target field bus address 9 from the static range on the basis of the first device identification data 8a and a table stored in the data memory of master unit 1, wherein this target field bus address 9 has the value 50. This target field bus address 9 is transmitted to the fifth new slave unit 2e by means of an address setting message 11 and programmed into the fifth new slave unit 2e so that the target field bus address 9 acts as the new address of the fifth new slave unit 2e. Subsequently, the master unit 1 transmits a locking command 10 to the fifth new slave unit 2e. As a result, the fifth new slave unit 2e exits configuration mode and ignores future configuration commands 6 until another unlocking command 5 is received. In this way, the target field bus address 9 of the fifth new slave unit 2e remains programmed.

According to the state of FIG. 4, the master unit 1 continues to query the addresses 215 to 230 in the dynamic range as already described for the addresses 201 to 246, wherein no responses are received to these queries because none of the new slave units 2a-f is assigned an address in this range. The corresponding readout commands are not shown here.

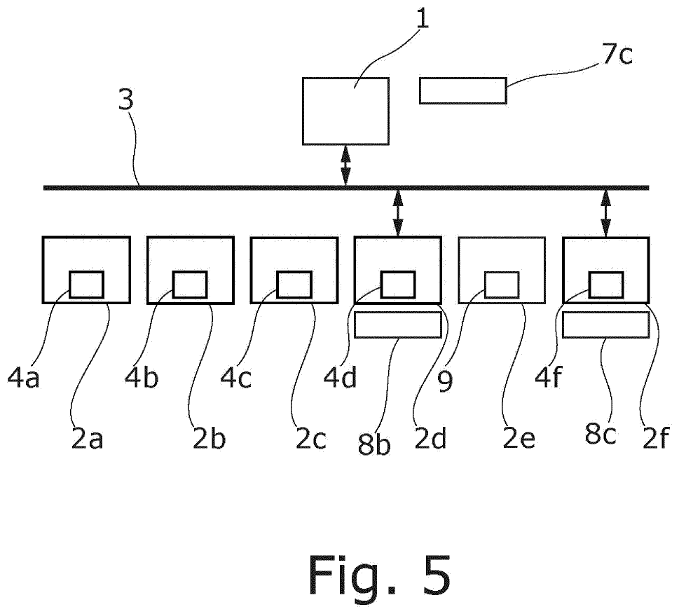

In the state of FIG. 5 in turn, the master unit 1 queries the address 231 in the dynamic range by sending a third readout command 7c to this very address. However, since both the fourth new slave unit 2d as well as the sixth new slave unit 2f have this address as the respective initial field bus address 4d, f, these two new slave units 2d, f both respond with respective device identification data 8b, c in a respective response message. The master unit 1 now recognizes either by receiving these two response messages or by a collision and thus an error in receiving these two response messages, which is caused by the simultaneous response of the two new slave units 2d, f, that two new slave units 2d, f the address 231 is assigned as the respective initial field bus address 4d, f.

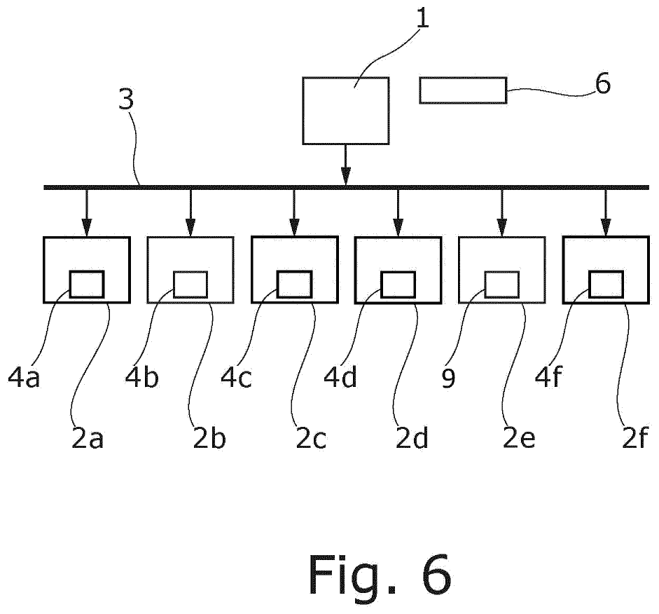

In order to resolve this collision, the master unit in the state of FIG. 6 again executes a configuration command 6 in the broadcast. Upon this configuration command 6 being made, a new pseudo-randomly generated initial field bus address from the dynamic range is programmed into all new slave units 2a-d, f with the exception of the fifth new slave unit 2e, which has received the locking command 10. Then proceed as described above for the processes after sending the first configuration command 6.

Since the fifth new slave unit 2e has already received a target field bus address 9 in the static range and does not need to be further configured, the risk of recurrent collisions in the dynamic range is also lower during this run.

1. A method for address configuration for a master/slave system via a field bus for serial data transmission, wherein a master unit is connected to the field bus, wherein a number range for addresses of slave units on the field bus is divided into a static range and a dynamic range, that at least one new slave unit is connected to the field bus, that a respective initial field bus address from the dynamic range is programmed into the at least one new slave unit, via which initial field bus address at least one new slave unit can be addressed, that the master unit queries the dynamic range of the addresses of slave units, that the master unit receives a respective response message from the at least one new slave unit to the query, that the master unit transmits a target field bus address from the static range to at least one new slave unit so that the target field bus address is programmed into the at least one new slave unit instead of the initial field bus address and so that at least one new slave unit can be addressed via the target field bus address.

2. The method according to claim 1, wherein querying the dynamic range comprises the sending of a respective query message per address in the dynamic range, wherein the respective query message is addressed to a single address in the dynamic range.

3. The method according to claim 1, wherein the response message comprises device identification data, wherein the device identification data comprise instrument-type information for specifying an instrument type of the respective new slave unit.

4. The method according to claim 1, wherein the master unit queries the dynamic range of the addresses of slave units by successively querying a series of continuous addresses, descending or ascending.

5. The method according to claim 1, wherein before querying the dynamic range, the master unit sends out a configuration command in the broadcast via which at least one new slave unit is put into a configuration mode, that a respective random address from the dynamic range is programmed into the new slave units in configuration mode as an initial field bus address.

6. The method according to claim 5, wherein before the configuration command is sent out, the master unit sends out an unlocking command in the broadcast via which at least one new slave unit is programmed to be put into configuration mode upon receipt of the configuration command.

7. The method according to claim 5, wherein the master unit transmits a locking command the at least one new slave unit after transmitting the target field bus address, via which at least one new slave unit is programmed to ignore the configuration command.

8. The method according to claim 1, wherein the response message, comprises manufacturer's information to specify a manufacturer of the respective new slave unit, a serial number of the respective new slave unit, a software version number to indicate a version of a software on the respective new slave unit, production data to provide information about the production of the respective new slave unit and/or specification data for the specification of the respective new slave unit.

9. The method according to claim 1, wherein a plurality of new slave units are connected to the field bus, that a respective initial field bus address is programmed into each new slave unit of the plurality of new slave units, via which respective initial field bus address the respective new slave unit can be addressed, that the master unit receives the respective response message from at least one new slave unit of the plurality of new slave units.

10. The method according to claim 9, wherein if the master unit receives the respective response message from exactly one new slave unit of the plurality of new slave units, the master unit transmits to exactly one new slave unit the target field bus address, wherein the target field bus address is programmed into the exactly one new slave unit instead of the initial field bus address so that the new slave unit can be addressed via the target field bus address, that after transmitting the target field bus address to exactly one new slave unit, the master unit queries a next address in the dynamic range.

11. The method according to claim 9, wherein when the master unit responds to a query of an address from the dynamic range receives the respective response message from more than one new slave unit of the plurality of new slave units, the master unit queries a next address from the dynamic range.

12. The method according to claim 9, wherein when the master unit receives the respective response message from more than one new slave unit of the plurality of new slave units in response to a query of an address from the dynamic range, the master unit, after substantially complete query of the dynamic range, puts the more than one new slave unit into a configuration mode so that a random address from the dynamic range is programmed as the initial field bus address into the respective more than one new slave unit.

13. The method according to claim 1, wherein, based on the response message, an additional information set is determined from an instrument database and the new slave unit is programmed based on the additional information set.

14. A method for address configuration for a master/slave system via a field bus for serial data transmission, wherein a master unit is connected to the field bus, wherein a number range for addresses of slave units on the field bus is divided into a static range and a dynamic range, that a new slave unit is connected to the field bus, that a respective initial field bus address is programmed from the dynamic range into the new slave unit, via which initial field bus address the new slave unit can be respectively addressed, that the new slave unit transmits a response message to the master unit in response to a query from the master unit, that the new slave unit receives a target field bus address from the static range from the master unit and that the target field bus address is programmed into the new slave unit instead of the initial field bus address so that the new slave unit can be addressed via the target field bus address.

15. A master unit for a master/slave system, which master/slave system uses a field bus for serial data transmission, wherein the master unit can be connected to the field bus, wherein a number range for addresses of slave units on the field bus is divided into a static range and a dynamic range, that the master unit is set up to query the dynamic range of the addresses of slave units, that the master unit is set up to receive a respective response message to the query from the at least one new slave unit, that the master unit is set up to transmit a target field bus address from the static range to at least one new slave unit so that the target field bus address is programmed into the at least one new slave unit instead of the initial field bus address and so that the at least one new slave unit can be addressed via the target field bus address.

16. The master/slave system with a field bus for serial data transmission wherein the master/slave system comprises the master unit connected to the field bus according to claim 14 and a new slave unit connected to the field bus, that a respective initial field bus address from the dynamic range is programmed into the new slave unit, via which initial field bus address the new slave unit can be respectively addressed, that the new slave unit is set up to transmit a response message to the master unit to a query of the master unit, that the new slave unit is set up to receive a target field bus address from the static range from the master unit, and that the new slave unit is set up to program in the target field bus address instead of the initial field bus address so that the new slave unit can be addressed via the target field bus address.
